(19) United States
(12) Patent Application Publication
(10) Pub. No.: US 2018/0365306 A1
(43) Pub. Date: Dec. 20, 2018

(54) System and Method for Query Optimized Modeling

(71) Applicant: erwin, Inc., Melville, NY (US)

(72) Inventor: Prashant Parikh, Holtsville, NY (US)

(73) Assignee: erwin, Inc., Melville, NY (US)

(21) Appl. No.: 15/808,836

(22) Filed: Nov. 9, 2017

Related U.S. Application Data
(60) Provisional application No. 62/520,479, filed on Jun. 15, 2017.

(51) Int. Cl. G06F 17/30

(52) U.S. Cl. CPC G06F 17/30569; G06F 17/30595; G06F 17/30294

(57) ABSTRACT

Various implementations of the invention relate to converting SQL databases into improved databases that are optimized for querying. Such improved databases may include NoSQL databases that may have been optimized for querying.

### CROSS-REFERENCE TO RELATED APPLICATIONS

This Application claims priority to U.S. Provisional Patent Application No. 62/520,479, entitled “System and Method for Query Optimized Modeling,” and filed on Jun. 15, 2017. The foregoing application is incorporated herein by reference in its entirety.

### FIELD OF THE INVENTION

The invention is generally related to databases and more particularly, to transforming structured query language (SQL) databases into improved databases optimized for querying.

### BACKGROUND OF THE INVENTION

Various conventional database management systems rely on a structured query language (SQL) to communicate with a relational database. These relational databases (referred to herein as SQL databases) are often organized as tables (sometimes referred to as objects) with information (e.g., data) of the database stored in these tables. Tables are uniquely identified by name and include columns and rows. Each column may include a column name, a data type, and any other attributes for the column as would be appreciated. Each row may include a record or data value for each respective column.

Conventional SQL databases are typically normalized. Normalization eliminates redundant data so that the same data is not stored in more than one table. Normalization also ensures that data dependencies make sense by only storing data in a table. In principle, normalization reduces an amount of space a database consumes and ensures that data is logically stored. In essence, conventional SQL databases are organized around the data and in particular, the data's relationships to other data in the database.

Querying (i.e., interfacing to) SQL databases is a complex and arduous activity. SQL queries require intimate knowledge of the SQL database and its organization. As a result, new or modified queries of the SQL database require significant resources in terms of time and effort to code, test, and ultimately implement.

Scaling SQL databases provides additional challenges—doing so often requires specialized hardware. With commodity hardware, SQL databases are particularly difficult to scale horizontally.

In contrast to SQL databases, NoSQL databases (i.e., “non SQL databases,” “not only SQL databases,” etc.) store data in an unstructured way and scale very easily horizontally using commodity hardware. Query performance is more than satisfactory even for databases comprising terabytes (TB) or petabytes (PB) of data.

Even though NoSQL databases provide a superior solution, migrating data from an SQL database to a NoSQL database in terms of a data layout (or schema) proves to be an impediment.

What is needed is an improved system and method for organizing an NoSQL database based on an existing SQL database to assist with migrating the data layout from SQL to NoSQL.

### SUMMARY OF THE INVENTION

Various implementations of the invention relate to converting SQL databases into improved databases that are optimized for querying. Such improved databases may include NoSQL databases that may have been optimized for querying.

These implementations, their features and other aspects of the invention are described in further detail below.

### BRIEF DESCRIPTION OF THE DRAWINGS

FIG. 1A illustrates a system for creating a query optimized model (QOM) database according to various implementations of the invention.

FIG. 1B illustrates a system for creating a query optimized model (QOM) database according to various implementations of the invention.

FIG. 2A illustrates an operation of a system for creating a QOM database according to various implementations of the invention.

FIG. 2B illustrates an operation of a system for creating a QOM database according to various implementations of the invention.

FIG. 2C illustrates an operation of a system for creating a QOM database according to various implementations of the invention.

FIG. 3 illustrates a data schema for a SQL database according to various implementations of the invention.

FIG. 4 illustrates a first data schema for a NoSQL database according to various implementations of the invention.

FIG. 5 illustrates a second data schema for a NoSQL database according to various implementations of the invention.

FIG. 6 illustrates an exemplary operation of a model converter as it generates a logical data schema for a NoSQL database from an SQL schema according to various implementations of the invention.

### DETAILED DESCRIPTION

Various implementations of the invention are directed toward an improved database model that utilizes an NoSQL database. This improved model considers the types of queries to be applied against the database and organizes the data in accordance with these queries. In other words, the improved model is developed based on a user's queries as opposed to a user's data (as with SQL databases). The resulting NoSQL database developed within the rubric of this improved model is referred to as a query optimized model (QOM) NoSQL database.

As would be appreciated, an SQL database typically has a single “correct” data model or schema. With NoSQL databases, there are many “correct” data models or schemas. With NoSQL databases, the data is laid out in the database according to various factors regarding use of the data (e.g., how the data is queried, how frequently the data changes, how much data is stored, and/or other factors regarding use of the data) as would be appreciated.

Query optimized modeling in accordance with various implementations of the invention builds upon this NoSQL modeling approach. NoSQL databases provide a mechanism for storing and retrieving data which is modeled in ways other than the tables (or objects) used by conventional relational databases (e.g., SQL databases). NoSQL databases adopt (and in some cases, encourage) concepts of denormalization and duplication. Various implementations of NoSQL databases may avoid joins of tables, may not utilize foreign keys (FK), may not utilize secondary indices, may perform atomic writes at a document level, and/or may prefer denormalized and embedded documents.

Various types of NoSQL databases are available, and may be used in various implementations of the invention, including, but not limited to: Apache Cassandra, an open-source distributed NoSQL database management system available from Apache Software Foundation (www.cassandra.apache.org); MongoDB, an open-source distributed NoSQL database management system available from MongoDB Inc. (www.mongodb.com); Amazon DynamoDB, a fully managed proprietary NoSQL database management system available from Amazon Web Services (www.amazon.com); Couchbase Server, an open-source distributed NoSQL database management system available from Couchbase, Inc. (www.couchbase.com); Redis, an open-source NoSQL database management system available from Redis Labs (www.redis.io); and other NoSQL databases.

Each of the forementioned NoSQL databases has various strengths and weaknesses. For example, Cassandra is well suited for querying single-rows, or querying/selecting multiple rows based on a “column-value” index; does not utilize a foreign key; does not utilize a secondary index; does not utilize “joins;” favors denormalization and/or duplication; good for storing time sequenced data; and other strengths as would be appreciated. For example, MongoDB provides flexibility with data models; provides elastic scalability; is essentially “schema free;” does not utilize a foreign key or primary key; provides atomic write at a document level; does not experience data loss with denormalized and/or embedded data; and other strengths as would be appreciated. Other NoSQL databases, with their own attendant strengths and weaknesses, may be used as would be appreciated.

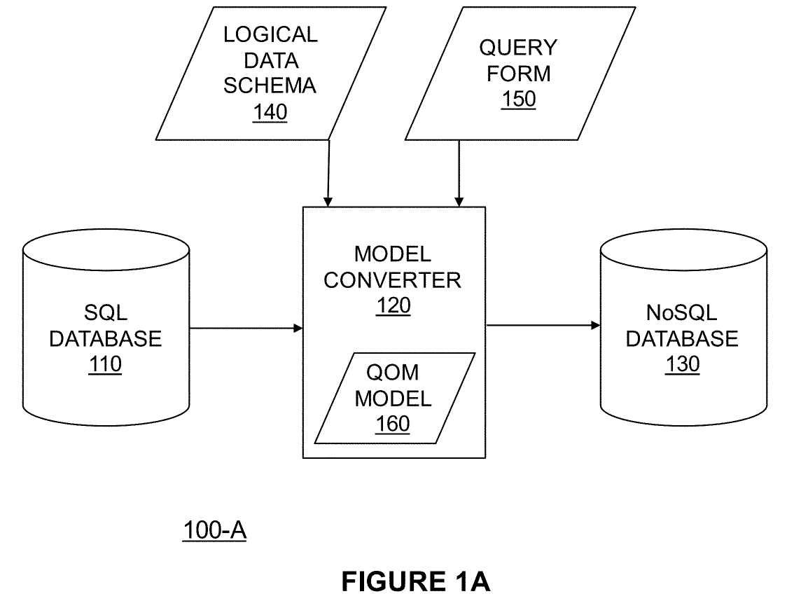

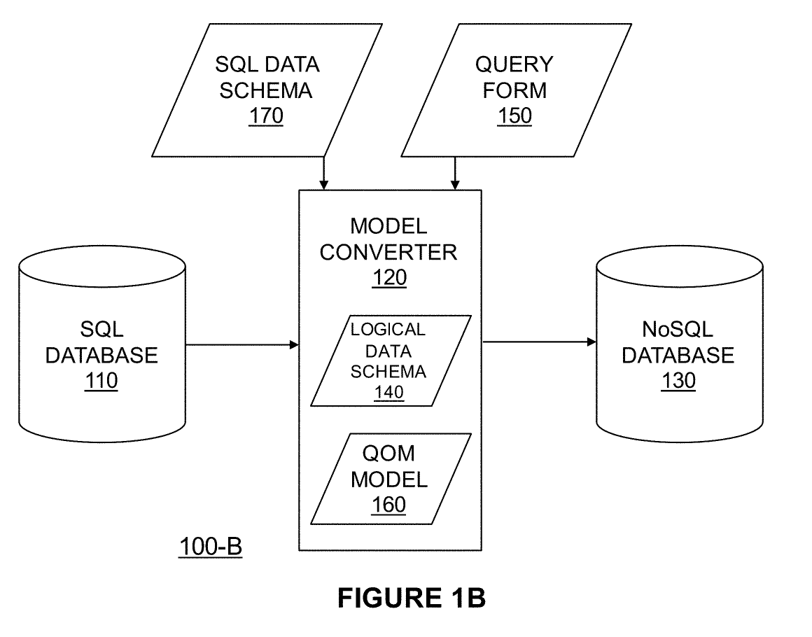

FIG. 1A illustrates a system 100 for creating a query optimized model (QOM) NoSQL database according to various implementations of the invention. According to the various implementations of the invention, a model converter 120 converts a SQL database 110 to a NoSQL database 130. Stated somewhat more precisely, model converter 120 ports relevant data from SQL database 110 to NoSQL database 130.

As would be appreciated, SQL database 110 corresponds to any relational database that utilizes a structured query language to interface with the database. SQL database 110 organizes its data based on various relationships among the data in accordance with an SQL data schema (not otherwise illustrated in FIG. 1A) for SQL database 110 as would be appreciated. Complex SQL queries provide access to the data in SQL database 110 as would also be appreciated.

According to various implementations of the invention, model converter 120 may comprise various hardware, software, firmware, and/or any combination thereof, that may be configured to perform various features of the invention, including the features described herein, as would be appreciated. Once so configured, model converter 120 becomes a particular machine configured to implement various features and aspects of the invention as would be appreciated. In some implementations of the invention, model converter 120 includes a computing processor and a memory (not otherwise illustrated), where the memory is configured to store instructions that, when executed by the computing processor, implement and/or perform various features and aspects of the invention, again, as would be appreciated.

In some implementations of the invention, model converter 120 receives a logical data schema 140 as an input. In some implementations of the invention, logical data schema 140 corresponds to a new schema for the data from SQL database 110, which may include the nature of the data from SQL database 110. (For purposes of clarity, this logical data schema 140 is a new schema is to be used for NoSQL database 130 and is different from the SQL data schema that describes the data for the purposes of existing SQL database 110. Logical data schema 140 provides a new characterization, one might say, of the SQL data schema of SQL database 110.) In some implementations of the invention, logical data schema 140 corresponds to a loose organizational grouping for the data from SQL database 110. In some implementations of the invention, logical data schema 140 corresponds to the nature of the data from SQL database 110 as well as the loose organization grouping of the data from SQL database 110.

In some implementations of the invention, a user prepares a drawing (not otherwise illustrated) of logical data schema 140. This drawing may be a paper drawing, an electronic drawing, an electronically rendered drawing, or other form of drawing (e.g., an optically scanned paper drawing, etc.) or graphical depiction that may be rendered by the user and subsequently received and interpreted by model converter 120 as would be appreciated. Other mechanisms for rendering logical data schema 140 and providing it for receipt by model converter 120 may be used as would be appreciated. For example, one such tool useful for rendering logical data schema is erwin Data Modeler, which is a software tool for data modeling, and is available from erwin, inc. (www.erwin.com). Other mechanisms for entering logical data schema 140 into model converter 120 may be also be used as would be appreciated.

In some implementations of the invention, such as that illustrated in FIG. 1B, model converter 120 receives an SQL data schema 170 that describes the data in existing SQL database 110 and generates a new logical data schema 140 from SQL data schema 170. In some implementations of the invention, model converter 120 evaluates SQL data schema 170, assesses SQP data schema 170 relative to characteristics and/or features of NoSQL database 130, and modifies SQL data schema 170 to generate logical data schema 140 that reflects the characteristics and/or features of NoSQL database 130.

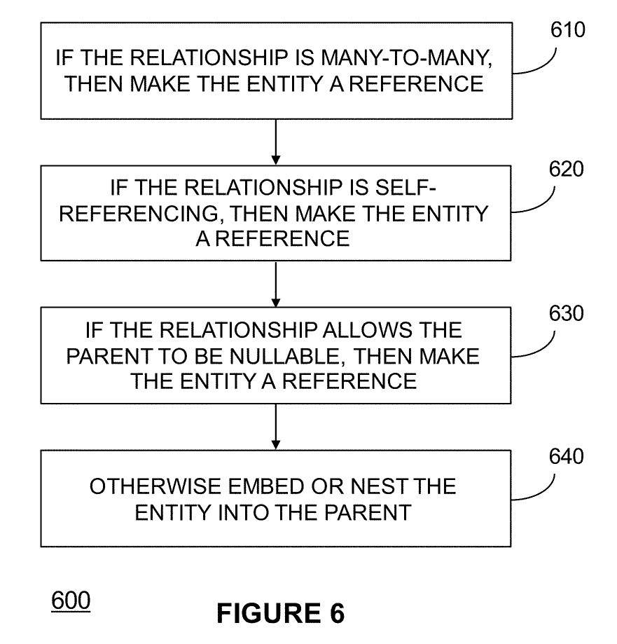

For example, when NoSQL database 130 corresponds to MongoDB, model coverter 120 typically denormalizes SQL data schema 170 to take advantage of the features of MongoDB. In some implementations of the invention, model converter 120 evaluates each relationship in SQL data schema 170 to determine whether a particular child entity in SQL data schema 170 will be a nested collection. FIG. 6 illustrates an example of an operation 600 of model converter 120 as it evaluates each relationship in SQL data schema 170, modifies SQL data schema 170, and generates logical data schema 140. More specifically, FIG. 6 illustrates operation 600 of model converter 120 as it converts SQL data schema 170 to logical data schema 140 when NoSQL database 130 corresponds to MongoDB.

When model converter 120 encounters a relationship in SQL data schema 170, model converter 120 determines whether: 1) the relationship is many-to-many; 2) the relationship is self-referencing; and/or 3) the relationship defined with the parent is allowed to be nullable. If model converter 120 determines that any of these are true, then the resultant entity will be made a references; otherwise, if model converter 120 determines that none of these are true, then the resultant entity may be nested or embedded into the parent collection.

Operation 600 is performed for each relationship in SQL data schema 170 that is encountered by model coverter 120. Operation 600 is now described in reference to FIG. 6. In an operation 610, model coverter 120 determines whether the relationship in SQL data schema 170 is many-to-many; if so, model converter 120 creates a reference for the corresponding entity. In an operation 620, model coverter 120 determines whether the relationship in SQL data schema 170 is self-referencing; if so, model converter 120 creates a reference for the corresponding entity. In an operation 630, model coverter 120 determines whether the relationship in SQL data schema 170 defined with the parent is allowed to be nullable; if so, model converter 120 creates a reference for the corresponding entity. In an operation 640, when model converter 120 does not create a reference for the corresponding entity, then model converter 120 may embed or nest the entity into its parent as would be appreciated.

As would be appreciated, model converter 120 performs operation 600 for each relationship encountered in SQL data schema 170 to generate logical data schema 140. In some implementations of the invention, a user may modify logical data schema 140 to address various considerations of, for example, whether a given entity should be fetchable on its own or whether a given entity may experience growth without bounds. In these examples, the entity should be referenced and logical data schema 140 modified accordingly. The user may use these or other considerations to modify logical data schema 140 as would be appreciated.

In some implementations of the invention, model converter 120 receives a query form 150 as an input. In some implementations of the invention, query form 150 corresponds to a form of a query a user may wish to apply against the data found in SQL database 110. In some implementation of the invention, query form 150 corresponds to table(s) (or entities) found in SQL database 110 and their existing usage. In some implementations of the invention, query form 150 corresponds to the nature of the data the user expects to receive in response to the query. In some implementations of the invention, query form 150 corresponds to a form of a query a user may wish to apply against the data in SQL database 110, table(s) (or entities) found in SQL database 110 and their existing usage, and/or the nature of the data the user expects to receive in response to the query.

As would be appreciated, model converter 120 may generate or modify logical data schema 140 to address various considerations associated with the query, for example, whether a given query regularly requires retrieval of a particular entity by itself. In such cases, the particular entity should be referenced and model converter 120 may modify logical data schema 140 accordingly. For example, if NoSQL database 130 corresponds to Cassandra (which is more query/result oriented than MongoDB, for example), the query itself may dictate how model converter 120 generates logical data schema 140 from SQL data schema 170 as would be appreciated. Other considerations may be utilized by model converter 120 to modify logical data schema 140 as would be appreciated.

In some implementations of the invention, model converter 120 uses logical data schema 140 and query form 150 to generate a QOM model 160. In some implementations of the invention, QOM model 160 corresponds to instructions, statements, code, or scripts (depending upon the underlying NoSQL database) required to convert the data found in SQL database 110 to data in NoSQL database 130. For example, in implementations where the NoSQL database 130 corresponds to Cassandra, QOM model 160 corresponds to “create statements;” whereas in implementations where the NoSQL database corresponds to MongoDB, QOM model 160 corresponds to “insert statements.” Use of other types of NoSQL databases would result in other forms of QOM model 160 as would be appreciated.

In some implementations of the invention, with QOM model 160 in place, model converter 120 converts the data found in SQL database 110 to corresponding data in NoSQL database 130.

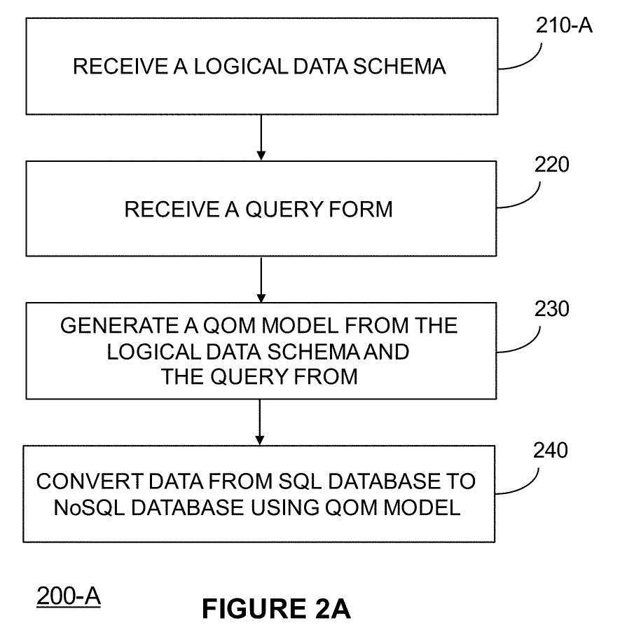

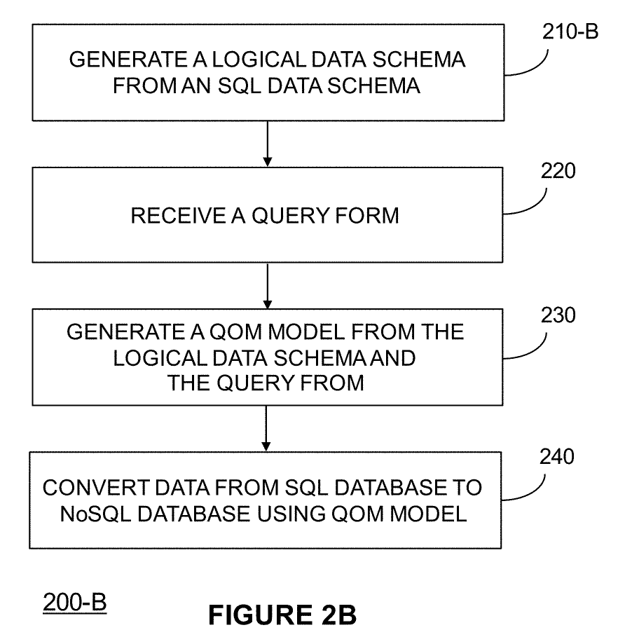

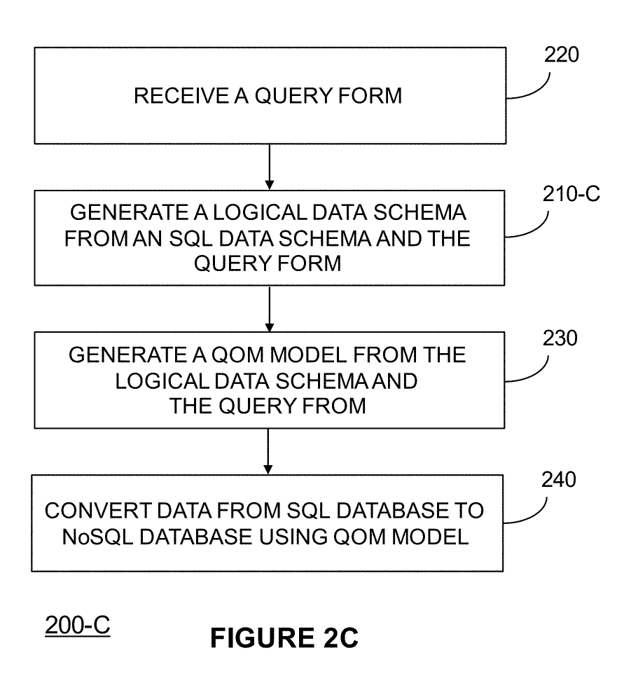

FIG. 2A illustrates an operation 200-A of model converter 120 according to various implementations of the invention. In an operation 210-A, model converter 120 receives a logical data schema 140. In an operation 220, model converter 120 receives a query form 150. In an operation 230, model converter 120 generates a QOM model 160 from logical data schema 140 and query form 150. In an operation 240, model converter 120 uses QOM model 160 to convert the data from SQL database 110 to NoSQL database 130.

FIG. 2B illustrates an operation 200-B of model converter 120 according to various implementations of the invention. In an operation 210-B, model converter 120 receives an SQL data schema 170 and generates a logical data schema 140 from SQL data schema 170. As before, in operation 220, model converter 120 receives query form 150. As before, in operation 230, model converter 120 generates QOM model 160 from logical data schema 140 and query form 150. As before, in operation 240, model converter 120 uses QOM model 160 to convert the data from SQL database 110 to NoSQL database 130.

FIG. 2C illustrates an operation 200-C of model converter 120 according to various implementations of the invention. As before, in operation 220, model converter 120 receives query form 150. In an operation 210-C, model converter 120 receives an SQL data schema 170 and generates logical data schema 140 from both SQL data schema 170 and query form 150. As before, in operation 230, model converter 120 generates QOM model 160 from logical data schema 140 and query form 150. As before, in operation 240, model converter 120 uses QOM model 160 to convert the data from SQL database 110 to NoSQL database 130.

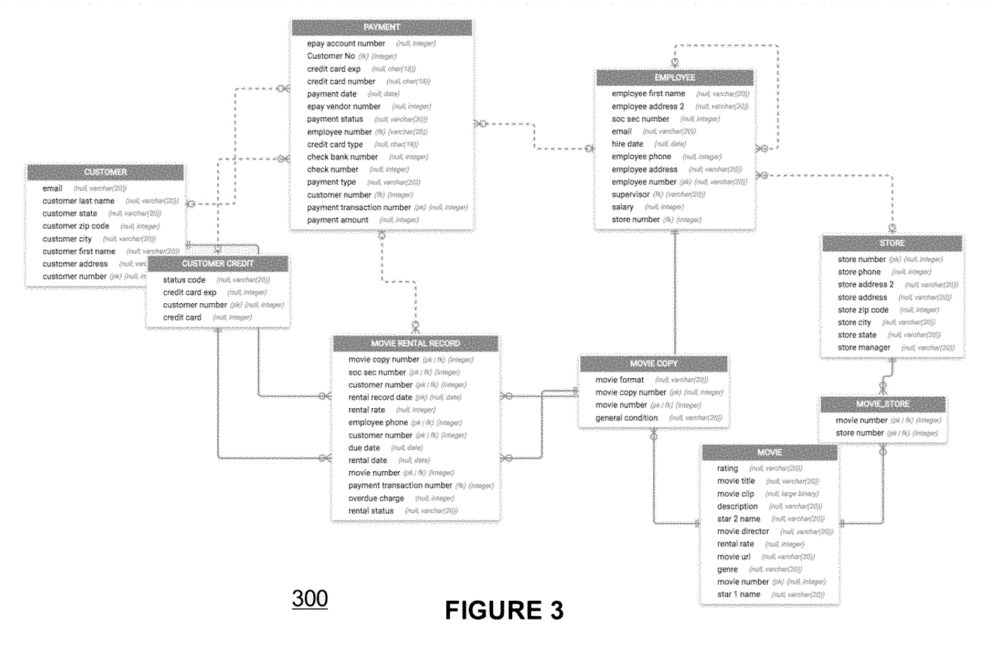

FIG. 3 illustrates an exemplary data schema 300 for a SQL database according to various implementations of the invention. As would be appreciated, data schema 300 corresponds to a single “correct” schema for the data in the associated SQL database.

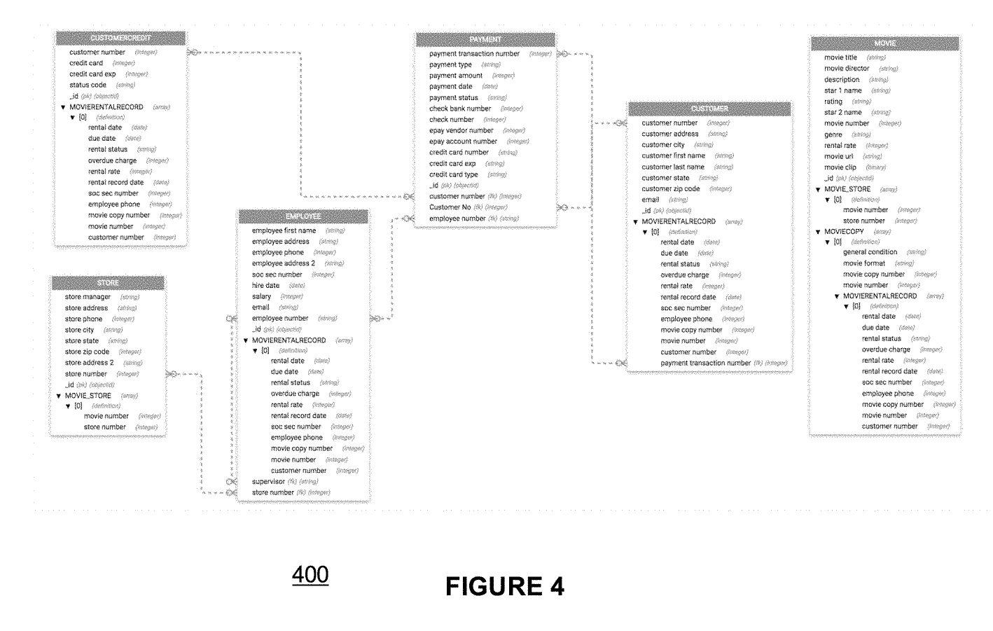

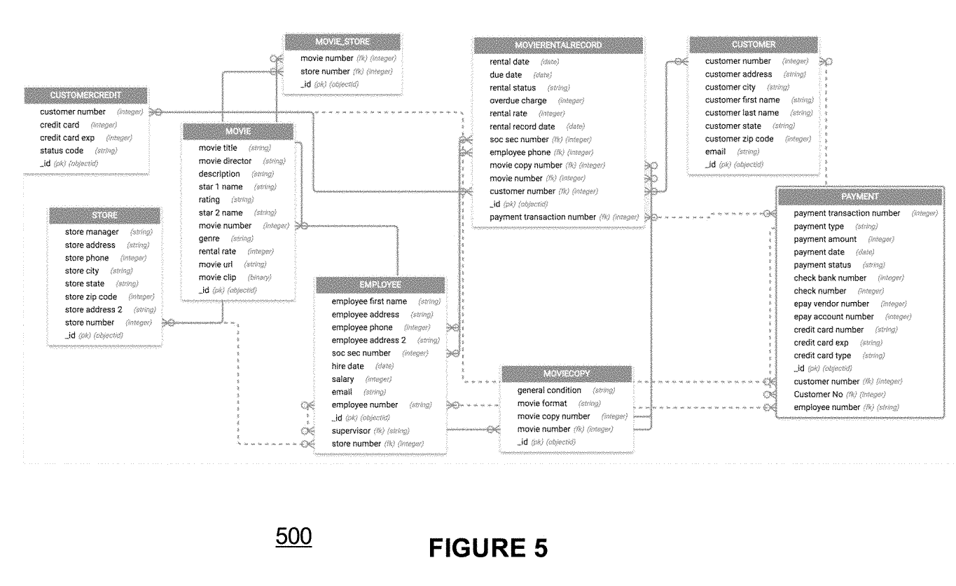

FIG. 4 and FIG. 5 illustrate different data schemas for a MongoDB NoSQL database that correspond to exemplary data schema 300 in FIG. 3. FIG. 4 illustrates a first data schema 400 for a NoSQL database according to various implementations of the invention, where the NoSQL database is a counterpart to the SQL database of FIG. 3. Likewise, FIG. 5 illustrates a second data schema 500 for a NoSQL database according to various implementations of the invention, where the NoSQL database is another counterpart to the SQL database of FIG. 3. First data schema 400 and second data schema 500 correspond to different approaches for modeling data depending on one or more data use factors discussed above. For purposes of comparison, first data schema 400 is a more typical NoSQL schema, whereas second data schema 500 is a more typical SQL schema; first data schema 400 will typically have higher performance that second data schema 500, however, second data schema 500 will typically be easier that first data schema 400 for most SQL developers to understand.

While the invention has been described herein in terms of various implementations, it is not so limited and is limited only by the scope of the following claims, as would be apparent to one skilled in the art. These and other implementations of the invention will become apparent upon consideration of the disclosure provided above and the accompanying figures. In addition, various components and features described with respect to one implementation of the invention may be used in other implementations as well.

1. A method comprising:
generating or receiving a logical data schema that recharacterizes existing data in an SQL database;
receiving a query form that corresponds to a query that a user may wish to apply against the existing data in the SQL database, that corresponds to tables found in the SQL database and an existing usage of the tables, or that corresponds to a nature of data the user expects to receive in response to a query;
generating a query optimized model (QOM) model of a NoSQL database using the logical data schema and the query form; and
converting the existing data from the SQL database to a NoSQL database using the QOM model.

2. The method of claim 1, wherein generating or receiving a logical data schema that recharacterizes existing data in an SQL database comprises:
generating the logical data schema from an SQL data schema of the SQL database.

3. The method of claim 1, wherein generating or receiving a logical data schema that recharacterizes existing data in an SQL database comprises:
generating the logical data schema from an SQL data schema of the SQL database and from the query form.

4. The method of claim 1, wherein generating or receiving a logical data schema that recharacterizes existing data in an SQL database comprises:
receiving the logical data schema from a user.

5. The method of claim 1, wherein the NoSQL database is a MongoDB database.

6. The method of claim 1, wherein the NoSQL database is a Cassandra database.

7. The method of claim 2, wherein generating the logical data schema from an SQL data schema of the SQL database comprises:
for each relationship in the SQL data schema:
determining whether the relationship in the SQL data schema is many-to-many; and
if the relationship in the SQL data schema is many-to-many, then creating a reference for a corresponding entity.

8. The method of claim 2, wherein generating the logical data schema from an SQL data schema of the SQL database comprises:
for each relationship in the SQL data schema:
determining whether the relationship in the SQL data schema is self-referencing; and
if the relationship in the SQL data schema is self-referencing, then creating a reference for a corresponding entity.

9. The method of claim 2, wherein generating the logical data schema from an SQL data schema of the SQL database comprises:
for each relationship in the SQL data schema:
determining whether the relationship in the SQL data schema defined with a parent is allowed to be nullable; and
if the relationship in the SQL data schema defined with the parent is allowed to be nullable, then creating a reference for a corresponding entity.

10. The method of claim 2, wherein generating the logical data schema from an SQL data schema of the SQL database comprises:
for each relationship in the SQL data schema:
when a reference for a corresponding entity is not created, then embedding or nesting the corresponding entity into a parent.

11. A method comprising:
generating a logical data schema from an SQL data schema of an SQL database, where the logical data schema recharacterizes existing data in the SQL database, wherein generating the logical data schema comprises:
for each relationship in the SQL data schema:
determining whether the relationship in the SQL data schema is many-to-many, and when the relationship in the SQL data schema is many-to-many, creating a reference for a corresponding entity,
determining whether the relationship in the SQL data schema is self-referencing and when the relationship in the SQL data schema is self-referencing, creating a reference for a corresponding entity, and
determining whether the relationship in the SQL data schema defined with a parent is allowed to be nullable, and when the relationship in the SQL data schema defined with the parent is allowed to be nullable, creating a reference for a corresponding entity;
receiving a query form that corresponds to a query that a user may wish to apply against the existing data in the SQL database, that corresponds to tables found in the SQL database and an existing usage of the tables, or that corresponds to a nature of data the user expects to receive in response to a query;
generating a query optimized model (QOM) model of a NoSQL database using the logical data schema and the query form; and
converting the existing data from the SQL database to a NoSQL database using the QOM model.
